(19) United States
(12) Patent Application Publication
(10) Pub. No.: US 2025/0053971 A1
(43) Pub. Date: Feb. 13, 2025

(54) METHODS AND SYSTEMS FOR TRANSACTION LEVEL PRIVACY CONTROL

(71) Applicant: MASTERCARD INTERNATIONAL INCORPORATED, PURCHASE, NY (US)

(72) Inventors: Vijay Nath, Noida (IN); Kaushal Shetty, Thane (IN); Sachin Kumar Singh, Putin (IN)

(21) Appl. No.: 18/448,138

(22) Filed: Aug. 10, 2023

(51) Int. Cl. G06Q 20/38; G06Q 20/02; G06Q 20/40

(52) U.S. Cl. CPC G06Q 20/383; G06Q 20/02; G06Q 20/40; G06Q 2220/00

(57) ABSTRACT

Embodiments provide methods and systems for assigning privacy labels to payment transactions. The method performed by a system includes receiving user input for masking a subset of data fields of a plurality of data fields in transaction data of the payment transaction performed within a pre-defined time period of occurrence of the payment transaction. The method includes assigning a mask label to the subset of data fields in the transaction data. Upon receiving a transaction insight request for the payment transaction from a third party server, the method includes determining whether the mask label is assigned to the subset of data fields. The method includes generating masked transaction data for the payment transaction based, at least in part, on masking the subset of data fields associated with the payment transaction in the transaction data. The method includes facilitating the transfer of the masked transaction data to the third party server.

### TECHNICAL FIELD

The present disclosure relates to payment networks and, more particularly, to electronic methods and complex processing systems for assigning privacy labels to payment transactions in the payment networks.

### BACKGROUND

With the ever-increasing digitalization of the financial domain, a large number of service providers such as third-party service providers have started providing various Value-Added Services (VAS) to cardholders. Examples of such VAS may include providing spend analysis, monthly statements, intelligently curated budgets, reminders for recurring bill payments, billing insights, and the like to the cardholders. As may be understood, these service providers can provide such VAS as a result of the open banking system. The term ‘open banking’ refers to a banking practice that allows authorized service providers to have open access to cardholder banking, transaction, and other financial data from the issuing bank associated with the cardholder through the use of Application Programming Interfaces (APIs). Although the open banking system has proven to be of great utility and opportunity in the financial domain, it has also introduced various privacy concerns related to the abuse of the financial data (or transaction data) of the cardholder.

As may be understood, it has been observed that these service providers often misuse the transaction related insights gained from the transaction data of the cardholder for performing a variety of activities for financial gain. Examples of such activities include advertising targeted financial products, household products, or services to the cardholder based on these transaction related insights. For instance, a service provider may determine that the cardholder is likely to purchase baby products based on the insights gained from their transaction activity obtained from their transaction data. Now, the service provider may sell this insight to an advertisement provider that may deliver relevant advertisements related to baby products to the cardholder. Such activities are a blatant violation of the privacy of the cardholder.

Conventionally, government regulators have tried to protect the privacy of cardholders by making it mandatory for the service providers to gain the consent of the cardholder before using their transaction data for any purpose. As per regulations, this consent must be received from the cardholder by the service provider upon disclosing for what exact activities and which exact financial data will be procured by the service provider.

However, in the present implementation, such disclosures are provided to users in the form of term and service agreements. It should be understood that such agreements are generally difficult for the average cardholder to comprehend due to their complexity and the use of confusing legal language. Therefore, the cardholder may easily be misled into agreeing to terms and conditions that may lead to his transaction data being misused without his knowledge or actual consent. Further, the conventional approach is unable to provide the cardholder granular control over his financial data as well. In other words, these service providers can procure the entire transaction data of the cardholder corresponding to a plurality of payment transactions performed by them at once without providing the cardholder with the ability to control what data from the transaction data is provided at each payment transaction level.

Thus, there exists a technological need for technical solutions for assigning privacy labels to payment transactions thus, preventing the misuse of transaction data.

### SUMMARY

Various embodiments of the present disclosure provide methods and systems for assigning privacy labels to payment transactions.

In an embodiment, a computer-implemented method for masking a subset of data fields of a plurality of data fields in transaction data associated with a payment transaction is disclosed. The computer-implemented method performed by a server system includes receiving a user input for masking a subset of data fields of a plurality of data fields in transaction data associated with a payment transaction performed between a cardholder and a merchant. Herein, the user input is received within a pre-defined time period of occurrence of the payment transaction. Further, the method includes assigning a mask label to the subset of data fields in the transaction data. Upon receiving a transaction insight request for the payment transaction from a third party server, the method further includes determining whether the mask label is assigned to the subset of data fields. The method further includes generating masked transaction data for the payment transaction based, at least in part, on masking the subset of data fields associated with the payment transaction in the transaction data. The method further includes facilitating transfer of the masked transaction data to the third party server.

In another embodiment, a server system is disclosed. The server system includes a communication interface and a memory including executable instructions. The server system also includes a processor communicably coupled to the memory. The processor is configured to execute the instructions to cause the server system, at least in part, to receive a user input for masking a subset of data fields of a plurality of data fields in transaction data associated with a payment transaction performed between a cardholder and a merchant. Herein, the user input is received within a pre-defined time period of occurrence of the payment transaction. Further, the server system is caused to assign a mask label to the subset of data fields in the transaction data. Upon receiving a transaction insight request for the payment transaction from a third party server, the server system is further caused to determine whether the mask label is assigned to the subset of data fields. The server system is further caused to generate masked transaction data for the payment transaction based, at least in part, on masking the subset of data fields associated with the payment transaction in the transaction data. The server system is further caused to facilitate transfer of the masked transaction data to the third party server.

In yet another embodiment, a non-transitory computer-readable storage medium is disclosed. The non-transitory computer-readable storage medium includes computer-executable instructions that, when executed by at least a processor of a server system, cause the server system to perform a method. The method includes receiving a user input for masking a subset of data fields of a plurality of data fields in transaction data associated with a payment transaction performed between a cardholder and a merchant. Herein, the user input is received within a pre-defined time period of occurrence of the payment transaction. Further, the method includes assigning a mask label to the subset of data fields in the transaction data. Upon receiving a transaction insight request for the payment transaction from a third party server, the method further includes determining whether the mask label is assigned to the subset of data fields. The method further includes generating masked transaction data for the payment transaction based, at least in part, on masking the subset of data fields associated with the payment transaction in the transaction data. The method further includes facilitating transfer of the masked transaction data to the third party server.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary representation of an environment related to at least some example embodiments of the present disclosure;

FIG. 2 illustrates a simplified block diagram of a server system, in accordance with an embodiment of the present disclosure;

FIG. 3A is a sequence flow diagram depicting a process for assigning at least one of a private label or a public label to an ongoing payment transaction by a cardholder in a payment network, in accordance with an embodiment of the present disclosure;

FIG. 3B is a sequence flow diagram depicting a process for assigning at least one of a private label or a public label to a completed payment transaction by a cardholder in a payment network, in accordance with an embodiment of the present disclosure;

FIG. 4A illustrates a block diagram representation of a process of sharing or transmitting masked transaction data to at least one of the plurality of service providers, in accordance with an embodiment of the present disclosure;

FIG. 4B illustrates a block diagram representation of a process of sharing or transmitting masked transaction data to at least one of the plurality of service providers, in accordance with an embodiment of the present disclosure;

FIGS. 5A and 5B, collectively, represent a series of exemplary Graphical User Interfaces (GUIs) implemented on an electronic device for assigning a private label or a public label to a payment transaction, in accordance with one or more embodiments of the present disclosure;

FIG. 6 illustrates a process flow diagram depicting a method for assigning at least one of a private label or a public label to a completed payment transaction by a cardholder, in accordance with an embodiment of the present disclosure;

FIG. 7 illustrates a process flow diagram depicting a method for assigning at least one of a private label or a public label to an ongoing payment transaction by a cardholder, in accordance with an embodiment of the present disclosure;

FIG. 8 illustrates a process flow diagram depicting a method for masking a subset of data fields of a plurality of data fields in transaction data associated with a payment transaction, in accordance with an embodiment of the present disclosure;

FIG. 9 illustrates a simplified block diagram of the acquirer server, in accordance with an embodiment of the present disclosure;

FIG. 10 illustrates a simplified block diagram of the issuer server, in accordance with an embodiment of the present disclosure; and

FIG. 11 illustrates a simplified block diagram of the payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entirely hardware embodiment, an entirely software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

The terms “account holder”, “user”, “cardholder”, “consumer”, “buyer”, and “customer” are used interchangeably throughout the description and refer to a person who has a payment account or a payment card (e.g., credit card, debit card, etc.) associated with the payment account, that will be used by a merchant to perform a payment transaction. The payment account may be opened via an issuing bank or an issuer server.

The term “merchant”, used throughout the description generally refers to a seller, a retailer, a purchase location, an organization, or any other entity that is in the business of selling goods or providing services, and it can refer to either a single business location or a chain of business locations of the same entity.

The terms “payment network” and “card network” are used interchangeably throughout the description and refer to a network or collection of systems used for the transfer of funds through the use of cash substitutes. Payment networks may use a variety of different protocols and procedures in order to process the transfer of money for various types of transactions. Payment networks are companies that connect an issuing bank with an acquiring bank to facilitate an online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc. Examples of networks or systems configured to perform as payment networks include those operated by such as Mastercard®.

The term “payment card”, used throughout the description, refers to a physical or virtual card linked with a financial or payment account that may be presented to a merchant or any such facility to fund a financial transaction via the associated payment account. Examples of the payment card include, but are not limited to, debit cards, credit cards, prepaid cards, virtual payment numbers, virtual card numbers, forex cards, charge cards, e-wallet cards, and stored-value cards. A payment card may be a physical card that may be presented to the merchant for funding the payment. Alternatively, or additionally, the payment card may be embodied in the form of data stored in a user device, where the data is associated with a payment account such that the data can be used to process the financial transaction between the payment account and a merchant's financial account.

The term “payment account”, used throughout the description refers to a financial account that is used to fund a financial transaction. Examples of the financial account include, but are not limited to a savings account, a credit account, a checking account, and a virtual payment account. The financial account may be associated with an entity such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction”, “financial transaction”, “event”, and “transaction” are used interchangeably throughout the description and refer to a transaction of payment of a certain amount being initiated by the cardholder. More specifically, refers to electronic financial transactions including, for example, online payment, payment at a terminal (e.g., point of sale (POS) terminal), and the like. Generally, a payment transaction is performed between two entities, such as a buyer and a seller. It is to be noted that a payment transaction is followed by a payment transfer of a transaction amount (i.e., monetary value) from one entity (e.g., issuing bank associated with the buyer) to another entity (e.g., acquiring bank associated with the seller), in exchange of any goods or services.

OVERVIEW

Various embodiments of the present disclosure provide methods, systems electronic devices, and computer program products for assigning at least one of a privacy label or a public label to a payment transaction.

In an embodiment, the server system is configured to receive a transaction authorization message associated with a payment transaction performed between a cardholder and a merchant from an issuer server associated with the cardholder. In response to receiving the transaction authorization message, the server system is configured to generate and transmit a privacy notification message for the payment transaction to an electronic device associated with the cardholder. In an example, the privacy notification message includes a web link such that the web link is valid for a pre-defined time period. In a non-limiting example, the privacy notification message is at least one of a Short Message Service (SMS) and an Electronic mail (E-mail).

Further, the server system is configured to determine if the cardholder has selected the web link within a pre-defined time period, if the server system determines that the cardholder has not selected the web link within the pre-defined time period, then the server system may assign the public label to the payment transaction. It is noted that herein, assigning the public label comprises setting the privacy flag as the second state in the transaction data associated with the payment transaction.

Alternatively, if the server system determines that the cardholder has selected the web link within the pre-defined time period, the server system is configured to facilitate the display of a first Graphical User Interface (GUI) on the electronic device. The first GUI may include a first option for assigning a privacy label to the payment transaction and a second option for assigning a public label to the payment transaction. As may be understood, now the cardholder can either select the first option for indicating that the cardholder wishes to label the transaction as private or the second option for indicating that the cardholder wishes to label the transaction as public.

In the first scenario, the server system is configured to assign the privacy label to the payment transaction in response to detecting a selection of the first option by the cardholder. In the alternative scenario, the server system is configured to assign the public label to the payment transaction in response to detecting a selection of the second option by the cardholder. Herein, assigning the privacy label includes setting a privacy flag as a first state in the transaction data associated with the payment transaction, and assigning the public label includes setting the privacy flag as a second state in the transaction data associated with the payment transaction. In a particular implementation, the server system can be at least one of a payment server associated with a payment network and an issuer server associated with the cardholder. It is noted that a similar process initiated upon receiving a transaction authorization message may be initiated upon receiving a transaction authorization request message associated with the payment transaction from the merchant. For instance, in response to receiving the transaction authorization request message, the first GUI is generated followed by the assigning of the privacy labels and the public labels based on the selection of either the first option or the second option by the cardholder.

In another embodiment, upon detecting that the cardholder has selected the first option, the server system is configured to facilitate the display of a second GUI on the electronic device. In an implementation, the second GUI may include a set of masking options corresponding to a plurality of data fields associated with the payment transaction in the transaction data. Herein, each masking option of the set of masking options enables the cardholder to mask a corresponding data field from the plurality of data fields. Further, the server system is configured to receive a user input indicating a selection of a subset of masking options corresponding to the subset of data fields from the set of masking options by the cardholder.

Upon receiving the user input indicating a selection of a subset of masking options corresponding to the subset of data fields from the set of masking options by the cardholder, the server system is configured to assign a mask label to the subset of data fields in the transaction data. Herein, the user input is received within a pre-defined time period of occurrence of the payment transaction. Further, assigning the mask label includes masking the corresponding data field with a NULL value in the transaction data associated with the payment transaction. In an alternative scenario, after the pre-defined time period elapses, a public label may directly be assigned to the payment transaction.

Further, the server system is configured to receive a transaction insight request for the payment transaction from a third party server. Upon receiving the transaction insight request, the server system is configured to determine whether the mask label is assigned to the subset of data fields. Then, the server system is configured to generate masked transaction data for the payment transaction based, at least in part, on masking the subset of data fields associated with the payment transaction in the transaction data. Furthermore, the server system is configured to facilitate the transfer of the masked transaction data to the third party server.

In another embodiment, upon receiving this transaction insight request, the server system is configured to determine whether the privacy flag is set as one of the first state and the second state for the payment transaction based, at least in part, on the transaction data. Then, upon determining that the privacy flag is set as the second state, the server system is configured to transmit the transaction data to the third party server.

In another implementation, upon receiving the transaction insight request, the server system may at first determine a country code associated with the payment transaction based, at least in part, on the transaction data. Then, the server system may be configured to mask at least one of a plurality of data fields associated with the payment transaction with NULL values in the transaction data based, at least in part, on the country code and a set of pre-defined rules. Further, the server system is configured to generate regulated transaction data for the payment transaction based, at least in part, on the previous masking step. Thereafter, the server system is configured to transmit the regulated transaction data to the third party server associated with at least one of the plurality of service providers.

In another embodiment, in response to receiving the transaction authorization message the server system may be further configured to generate a transaction successful message including one or more transaction related information for the payment transaction. Herein, the one or more transaction related information is masked with NULL value based, at least in part, on determining that the privacy flag is set as the first state for the payment transaction based, at least in part, on the transaction data. Further, the server system is configured to transmit the transaction successful message comprising the masked one or more transaction related information to the electronic device associated with the cardholder. In a non-limiting example, the transaction successful message is at least one of a Short Message Service (SMS) and an Electronic mail (e-mail). It may be noted that the server system may be implemented as one of a payment server associated with a payment network and an issuer server associated with the cardholder.

Various embodiments of the present disclosure provide multiple advantages and technical effects while addressing technical problems such as how to curb the blatant violation of a cardholder's privacy by a plurality of service providers. Various embodiments address this technical problem by allowing the cardholder to either assign a privacy label or a public label to each individual payment transaction. This assignment of the privacy label or public label can be done for both ongoing and completed payment transactions. In other words, the embodiments of the present disclosure provide discrete or granular control to the cardholder over his/her privacy. Further, the various embodiments of the present disclosure enable a server system such as a payment server to mask a plurality of data fields in transaction data for a payment transaction by a plurality of techniques. A technique provides direct masking of the data fields with NULL values upon detecting that a transaction has been labeled with a private label. Another technique provides the cardholder a second GUI including a set of masking options from which the cardholder can select whichever data fields the cardholder wishes to mask with NULL values. Yet another technique provides automatic masking of the plurality of data fields for a payment transaction based on government regulations. Yet another technique masks the transaction related information within the NULL values to prevent the plurality of service providers from extracting insights directly from reading the transaction successful messages.

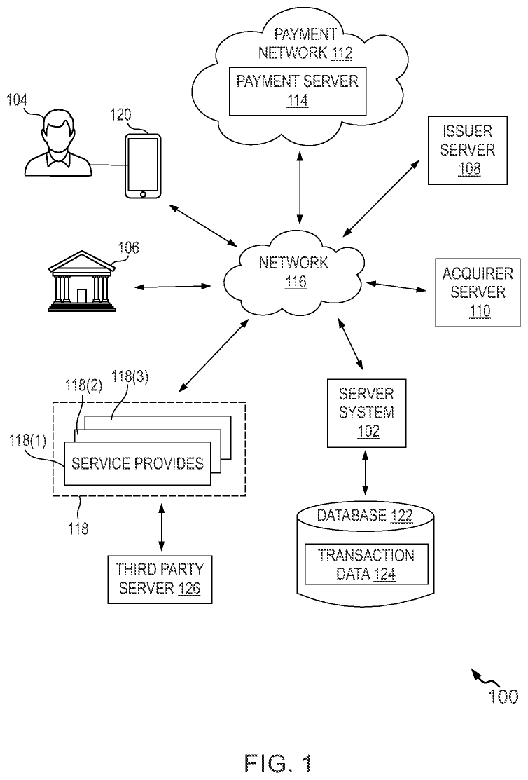

Various embodiments of the present disclosure are described hereinafter with reference to FIGS. 1 to 11.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, facilitating a cardholder (such as cardholder 104) to assign a privacy label or a public label to a payment transaction, facilitating the cardholder to mask a subset of data fields from a plurality of data fields associated with the payment transaction in a transaction data, and the like.

The environment 100 generally includes a plurality of entities such as a server system 102, a cardholder 104, a merchant 106, an issuer server 108, an acquirer server 110, and a payment network 112 including a payment server 114, service providers 118(1), 118(2), and 118(3) (collectively referred to hereinafter as a plurality of service providers 118), and a third-party server 126 associated with the plurality of service providers 118 each coupled to, and in communication with (and/or with access to) a network 116. The network 116 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infra-Red (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 116 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 116 may include multiple different networks, such as a private network made accessible by the server system 102 and a public network (e.g., the Internet, etc.) through which the server system 102, the issuer server 108, the acquirer server 110, the plurality of service providers 118 and the payment server 114 may communicate.

In an embodiment, the cardholders 104 may use one or more payment cards (not shown for the sake of brevity) respectively to make payment transactions. In various non-limiting examples, one or more payment cards may include a credit card, a debit card, and the like. As may be understood, the cardholder (e.g., the cardholder 104) may be any individual, representative of a corporate entity, a non-profit organization, or any other person that is presenting payment account details during an electronic payment transaction. The cardholder 104 may have a payment account issued by an issuing bank (not shown) associated with the issuer server 108 (explained later) and may be provided a payment card with financial or other account information encoded onto the payment card such that the cardholder may use the payment card to initiate and complete a payment transaction using a bank account at the issuing bank.

In another embodiment, the cardholder 104 may be associated with an electronic device (e.g. electronic device 120) to access a mobile application or a website associated with the issuing bank, or any third-party application associated with the plurality of service providers 118. In various non-limiting examples, the electronic device 120 may refer to any electronic device such as, but not limited to, a Personal Computer (PC), a tablet device, a Personal Digital Assistant (PDA), a voice-activated assistant, a Virtual Reality (VR) device, a smartphone, a laptop, and the like.

In an embodiment, the cardholder 104 is associated with the issuer server 108. In one embodiment, the issuer server is associated with a financial institution normally called an “issuer bank”, “issuing bank” or simply “issuer”, in which a cardholder (e.g., the cardholder 104) may have the payment account, (which also issues a payment card, such as a credit card or a debit card), and provides microfinance banking services (e.g., payment transaction using credit/debit cards) for processing electronic payment transactions, to the cardholder 104.

In an embodiment, the merchant 106 may be a retail shop, a restaurant, a supermarket or an establishment, a government and/or private agency, or any such places equipped with POS terminals, where customers such as the cardholder 104 may visit for performing the financial transaction in exchange for any goods and/or services. Such scenarios are an example of Card-Present (CP) transactions. In another embodiment, the merchant 106 may also be a digital retailer or digital service provider that has a digital platform where the cardholder 104 may logon to perform a financial transaction in exchange for any goods and/or services. In such a scenario, the transaction performed by the cardholder 104 is called a Card-Not-Present (CNP) transaction.

In an embodiment, the merchant 106 is associated with the acquirer server 110. In an embodiment, each merchant is associated with an acquirer server (e.g., the acquirer server 110). In one embodiment, the acquirer server 110 is associated with a financial institution (e.g., a bank) that processes financial transactions for the merchant. In other words, this can be an institution that facilitates the processing of payment transactions for physical stores, merchants (e.g., the merchant 106), or institutions that own platforms that make either online purchases or purchases made via software applications possible (e.g., the plurality of service providers 118, the shopping cart platform providers and the in-app payment processing providers). The terms “acquirer”, “acquiring bank”, “acquiring bank” or “acquirer server” will be used interchangeably herein.

In a non-limiting scenario, the cardholder 104 may use their corresponding payment account to conduct a payment transaction with the merchant 106. For instance, the cardholder 104 may enter payment account details on the electronic device 120 associated with the cardholder 104 to perform an online payment transaction with the merchant 106. In another example, the cardholder 104 may utilize their payment card to perform an offline payment transaction at a POS associated with the merchant 106. It is understood that generally, the term “payment transaction” as used herein, refers to an agreement that is carried out between a buyer (i.e., the cardholder 104) and a seller (i.e., the merchant 106) to exchange goods or services in exchange for assets in the form of a payment (e.g., cash, fiat-currency, digital asset, cryptographic currency, coins, tokens, etc.).

In an embodiment, the plurality of service providers 118 refers to third-party service providers that may correspond to financial institutions that provide a plurality of Value-Added Services (VAS) to cardholders. In a non-limiting example, the plurality of VAS may include providing spend analysis, monthly statements, intelligently curated budgets, reminders for recurring bill payments, billing insights, and the like to the cardholder 104. As may be understood, the plurality of service providers 118 may use the open banking system for providing this plurality of VAS to the cardholders. In particular, the plurality of service providers 118 utilize the open banking system to extract transaction related information associated with the transaction data of the cardholder 104 for a plurality of payment transactions performed by the cardholder 104 from the issuer server 108. In a non-limiting example, the plurality of service providers 118 may utilize Application Programming Interface (API) calls to request this transaction-related information from the issuer server 108. Upon receiving this transaction related information, the plurality of service providers may generate transaction level insights corresponding to each of the plurality of payment transactions to curate the details required for providing the plurality of VAS to the cardholder 104.

In an embodiment, the plurality of service providers 118 is associated with the third-party server 126. In an embodiment, each service provider of the plurality of service providers 118 is associated with a third party server (e.g., the acquirer server 126). In one embodiment, the third party server 126 is a server that is capable of generating, processing, and transmitting the various requests within the open banking system to extract transaction related information associated with the transaction data of the cardholder 104 for a plurality of payment transactions performed by the cardholder 104 from the issuer server 108. In a non-limiting example, the third party server 126 may generate and transmit utilize API calls on behalf of the plurality of service providers 118 to request this transaction-related information from the issuer server 108.

As described earlier, it has been observed that the service providers often misuse the transaction related insights gained from the transaction data of the cardholder 104 for performing a plurality of activities for financial gain. In various non-limiting examples, the plurality of activities may include advertising targeted financial products, household products, or services to the cardholder based on these transaction related insights. For instance, a service provider may determine that the cardholder is likely to purchase a new mobile phone based on the insights gained from their transaction activity obtained from their transaction data. Now, the service provider may sell this insight to an advertisement provider that may deliver relevant advertisements related to newly launched mobile phones to the cardholder. Furthermore, another service provider may sell insights related to the budget of the cardholder based on analyzing the average bank balance of the cardholder to the advertisement provider such that more targeted advertisements related to newly launched mobile phones within the budget of the cardholder 104 may be shown to the cardholder 104. As may be understood, this is a blatant violation of the privacy of the cardholder associated with their transaction data. Conventionally, government regulators have tried to protect the privacy of cardholders by making it mandatory for the service providers to gain the consent of the cardholder before using their transaction data for any purpose. As per regulations, this consent must be received from the cardholder by the service provider upon disclosing for what exact activities and which exact financial data will be procured by the service provider. However, such approaches as described earlier have not proved to be successful. Furthermore, there exists no approach for providing the cardholder with the ability to control exactly what data from the transaction data is provided at each payment transaction level for all of the plurality of payment transactions performed by them.

However, in the present implementation, such disclosures are provided to users in the form of term and service agreements. It should be understood that such agreements are generally difficult for the average cardholder to comprehend due to their complexity and the use of confusing legal language. Therefore, the cardholder may easily be misled into agreeing to terms and conditions that may lead to his transaction data being misused without his knowledge or actual consent. Further, the conventional approach is unable to provide the cardholder granular control over his financial data as well. In other words, these service providers can procure the entire transaction data of the cardholder corresponding to a plurality of payment transactions performed by them at once without their actual consent.

The above-mentioned technical problem among other problems is addressed by one or more embodiments implemented by the server system 102 of the present disclosure. In one embodiment, the server system 102 is configured to perform one or more of the operations described herein.

In an example, the server system 102 coupled with the database 122 is embodied within the payment server 114, however, in other examples, the server system 102 can be a standalone component (acting as a hub) connected to the acquirer server 108 and the issuer server 108. In one embodiment, the server system 102 may be associated with a database 122 coupled with the server system 102. The database 122 may be incorporated in the server system 102 or maybe an individual entity connected to the server system 102 or maybe a database stored in cloud storage. In one embodiment, the database 122 may store transaction data 124 and the like.

In other various examples, the transaction data 124 may correspond to transaction related information associated with a plurality of payment transactions performed by the cardholder 104 with different merchants. In particular, each data element of the transaction data 124 may correspond to a particular payment transaction performed between the cardholder 104 and a merchant (e.g. the merchant 106). Each data element of the transaction data may include, but is not limited to, a plurality of data fields including transaction attributes such as transaction amount, cardholder Permanent Account Number (PAN), transaction category, merchant name, Merchant Category Code (MCC), CNP Identifier (ID), CP ID, merchant ID, country code, category code, transaction date, transaction authorization date, transaction location related information (or geo-coordinates of the transaction), payment channel and the like.

In an embodiment, the server system 102 is configured to receive by a server system 102, a transaction authorization message associated with a payment transaction performed between a cardholder and a merchant from an issuer server associated with the cardholder. It is understood that the transaction authorization message indicates that the payment transaction between the cardholder and the merchant has been authorized by the issuer bank associated with the cardholder. Generally, the transaction authorization message is transmitted by the issuer server to the server system which in turn is configured to transmit this message to the cardholder for informing them that the transaction was successful. It is noted that in response to receiving the transaction authorization message the server system 102 may be configured to generate a privacy notification message for the payment transaction. In a non-limiting example, the privacy notification message may include at least a web link (or a Hyperlink associated with a website). As may be understood, the cardholder may visit this web link for assigning at least one of a privacy label or a public label to the payment transaction. In a non-limiting scenario, the web link may be valid for a pre-defined time period. In a non-limiting example, the pre-defined time period may be determined by an administrator (not shown) associated with the server system 102. In a non-limiting example, the pre-defined time period may be determined based at least in part on one or more business related policies of the issuing bank corresponding with the cardholder 104. In such a scenario, the issuing bank may inform the server system 102 regarding one or more business related policies for the cardholder or a group of cardholders of the issuer bank through one or more messages sent via the issuer server 108 associated with the issuing bank. For instance, the pre-defined time period may be at least one of 60 seconds, 180 seconds, 300 seconds, and the like. As may be understood, the web link may expire or become invalid after the pre-defined time period has elapsed unless the same is opened by the cardholder 104. Further, the server system 102 is configured to transmit the privacy notification message for the payment transaction to an electronic device associated with the cardholder.

In an embodiment, in response to a selection of the website link by the cardholder, the server system 102 is configured to facilitate a display of a first Graphical User Interface (GUI) on the display screen associated with the electronic device 120 of the cardholder 104. In various non-limiting examples, the first GUI may include, but is not limited to, a first option for assigning a privacy label to the payment transaction and a second option for assigning a public label to the payment transaction. In a particular implementation, a tick box or a toggle box may be displayed to the cardholder 104 for assigning either the private label or the public label to the payment transaction.

Further, the server system 102 is configured to perform at least one of a first step or a second step. In one implementation, the first step may include in response to a selection of the first option by the cardholder, assigning by the server system 102 the privacy label to the payment transaction. As may be understood for assigning the privacy label, the server system 102 is configured to a privacy flag as a first state in the transaction data associated with the payment transaction. More specifically, the server system 102 is configured to set a particular data field of the plurality of data fields included in the transaction data associated with the payment transaction as the first state.

In another implementation, the second step may include in response to a selection of the second option by the cardholder, assigning by the server system 102 the public label to the payment transaction As may be understood for assigning the public label, the server system 102 is configured to the privacy flag as a second state in the transaction data associated with the payment transaction. More specifically, the server system 102 is configured to set the particular data field of the plurality of data fields included in the transaction data associated with the payment transaction as the second state. In a non-limiting implementation, the particular data field may be data field 121 for transaction data corresponding to the ISO 8533 version (i.e., an example of conventionally used version transaction data).

In another scenario, where the payment transaction is ongoing (i.e., a live payment transaction) between the cardholder and the merchant, the server system 102 is configured to receive a transaction authorization request message associated with an ongoing payment transaction. Thereafter, in response to receiving the transaction authorization request message, the server system 102 is configured to facilitate the display of the first GUI on the electronic device of the cardholder 104. As described earlier, the first GUI may include, but is not limited to, a first option for assigning a privacy label to the payment transaction and a second option for assigning a public label to the payment transaction. Further, the server system 102 is configured to perform at least one of the first step or the second step described earlier. In other words, the server system 102 facilitates the cardholder 104 to assign at least one of the privacy label or the public label to each payment transaction even if the same is either ongoing or complete. To that end, the server system 102 provides the cardholder 104 with the ability to control the privacy level associated with each payment transaction performed by him either in real-time or retroactively within a pre-defined time period.

In one embodiment, the payment network 112 may be used by the payment card issuing authorities as a payment interchange network. Examples of the payment cards include debit cards, credit cards, etc. Similarly, examples of payment interchange networks include but are not limited to, a Mastercard® payment system interchange network. The Mastercard® payment system interchange network is a proprietary communications standard promulgated by Mastercard International Incorporated® for the exchange of electronic payment transaction data between issuers and acquirers that are members of Mastercard International Incorporated®. (Mastercard is a registered trademark of Mastercard International Incorporated located in Purchase, N.Y.).

It should be understood that the server system 102 is a separate part of the environment 100, and may operate apart from (but still in communication with, for example, via the network 116) any third-party external servers (to access data to perform the various operations described herein). However, in other embodiments, the server system 102 may be incorporated, in whole or in part, into one or more parts of the environment 100.

The number and arrangement of systems, devices, and/or networks shown in FIG. 1 are provided as an example. There may be additional systems, devices, and/or networks, fewer systems, devices, and/or networks, different systems, devices, and/or networks, and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 116, which may be specifically configured, via executable instructions, to perform steps as described herein, and/or embodied in at least one non-transitory computer-readable media.

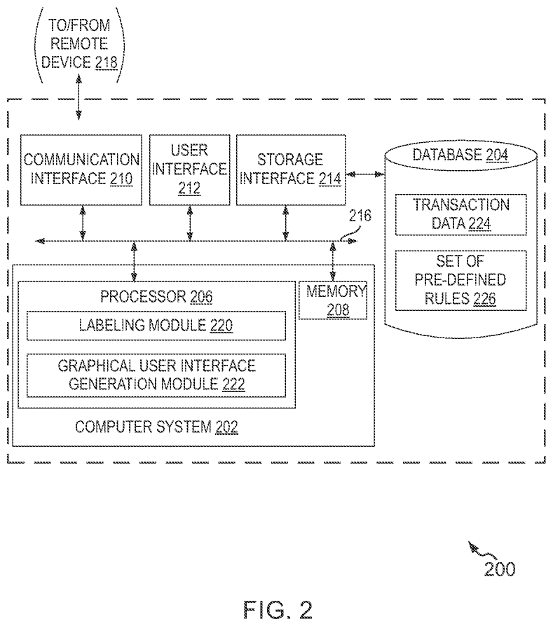

FIG. 2 illustrates a simplified block diagram of a server system 200, in accordance with an embodiment of the present disclosure. The server system 200 is identical to the server system 102 of FIG. 1. In one embodiment, the server system 200 is a part of the payment network 112 or integrated within the payment server 114. In some embodiments, the server system 200 is embodied as a cloud-based and/or software as a Service (SaaS) based (architecture.

The server system 200 includes a computer system 202 and a database 204. The computer system 202 includes at least one processor 206 for executing instructions, a memory 208, a communication interface 210, a user interface 212 and a storage interface 214 that communicates with each other via a bus 216.

In some embodiments, the database 204 is integrated within the computer system 202. For example, the computer system 202 may include one or more hard disk drives as the database 204. The user interface 212 is any component capable of providing an administrator (not shown) of the server system 200, the ability to interact with the server system 200. This user interface 212 may be a GUI or Human Machine Interface (HMI) that can be used by the administrator to configure the various operational parameters of the server system 200. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one non-limiting example, the database 204 is configured to store transaction data 224, set of predefined rules 226, and the like. It is noted that the transaction data 224 is identical to the transaction data 124 of FIG. 1.

The processor 206 includes suitable logic, circuitry, and/or interfaces to execute operations for determining, if a declared merchant category of a merchant is correct or incorrect. In other words, the processor 206 includes suitable logic, circuitry, and/or interfaces to execute operations for assigning one of a private label or public label to a payment transaction performed by a cardholder 104. Examples of the processor 206 include but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing operations. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device (i.e., to/from a remote device 218) such as the issuer server 108, the acquirer server 110, the payment server 114, the plurality of service providers 118, the third part server 126 or communicating with any entity connected to the network 116 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a labeling module 220, a Graphical User Interface (GUI) generation module 222, and the like.

It should be noted that components, described herein, such as the labeling module 220, and the GUI generation module 222 can be configured in a variety of ways, including electronic circuitries, digital arithmetic, and logic blocks, and memory systems in combination with software, firmware, and embedded technologies.

In an embodiment, the labeling module 220 includes suitable logic and/or interfaces for receiving a transaction authorization message associated with a payment transaction performed between a cardholder and a merchant from an issuer server associated with the cardholder. Thereafter, in response to receiving the transaction authorization message the labeling module 220 is configured to generate a privacy notification message for the payment transaction. In particular, the labeling module 220 may generate a web link corresponding to a webpage for enabling the cardholder to assign at least one of a privacy label or a public label to the payment transaction. In one particular implementation, the web link may be valid only for a pre-defined time period. Once this pre-defined time period is elapsed, the web link may become invalid. In a non-limiting example, the privacy notification message is at least one of a Short Message Service (SMS), an Electronic mail (e-mail), and the like.

In a particular scenario, while the web link is valid, if the labeling module 220 determines that the cardholder has selected the web link on their electronic device, the labeling module is configured to request the GUI generation module 222 to generate a first GUI on the display screen associated with the electronic device of the cardholder 104.

In an embodiment, the GUI generation module 222 includes suitable logic and/or interfaces for generating the first GUI in response to the request from the labeling module 220. In a non-limiting example, the first GUI may correspond to a payment gateway. In another example, the first GUI may include at least, a first option for assigning a privacy label to the payment transaction and a second option for assigning a public label to the payment transaction.

Further, if the labeling module 220 determines that the cardholder has selected the first option on the first GUI, the labeling module 220 is configured to assign the privacy label to the payment transaction. More specifically, the labeling module 220 is configured to set a privacy flag as a first state in a particular data field of the plurality of data fields included in the transaction data associated with the payment transaction to assign the privacy label. For instance, the first state may be one of 1 (one) or 0 (zero).

Furthermore, the labeling module 220 may be configured to request (i.e., a second request) the GUI generation module 222 to generate a second GUI on the display screen associated with the electronic device of the cardholder 104 in response to determining that the cardholder has selected the first option on the first GUI. As described earlier, the GUI generation module 222 is configured to generate the second GUI in response to the second request from the labeling module 220. In a non-limiting example, the second GUI may correspond to a payment gateway as well. In another example, the second GUI may include at least, a set of masking options corresponding to a plurality of data fields associated with the payment transaction in the transaction data 224. It is noted that each masking option of the set of masking options is configured to enable the cardholder to mask a corresponding data field from the plurality of data fields in transaction data for the corresponding transaction.

Further, if the labeling module 220 determines that the cardholder has selected a subset of masking options from the set of masking options by the cardholder, the labeling module 220 is configured to assign a mask label to the corresponding data field for each masking option of the selected subset of masking options. More specifically, the labeling module 220 is configured to mask the corresponding data field with a NULL value or a zero value in the transaction data associated with the payment transaction. As may be understood, once the values present inside these masked data fields are accessed by the plurality of service providers via one or more API calls, the plurality of service providers 118 will only receive the transaction data for the payment transaction including masked data fields with NULL values thereby, ensuring that the data fields marked as labeled cannot be accessed by the plurality of service providers 118.

Alternatively, if the labeling module 220 determines that the cardholder has selected the second option of the first GUI, the labeling module 220 is configured to assign the public label to the payment transaction. More specifically, the labeling module 220 is configured to set the privacy flag as a second state in the particular data field of the plurality of data fields included in the transaction data associated with the payment transaction to assign the privacy label. For instance, the first state may be one of zero (0) or one (1). It should be noted that the first state and the second state are complementary to each other.

Furthermore, in a particular scenario, the labeling module 220 may automatically assign the public label to the payment transaction based, at least in part, on determining that the cardholder has not selected the web link within the pre-defined time period. In other words, if the web page becomes invalid after the pre-defined time period has elapsed, the labeling module 220 may automatically assign a public label to the payment transaction. As described earlier, the process for assigning the public label includes assigning the public label comprises setting the privacy flag as the second state in the transaction data associated with the payment transaction.

In another embodiment, the labeling module 220 is configured to receive a transaction insight request for the payment transaction from at least one of a plurality of service providers 118 via the third party server 126. Upon receiving the transaction insight request, the labeling module is configured to determine whether the privacy flag is set as one of the first state or the second state for the payment transaction based, at least in part, on the transaction data. In one non-limiting scenario, upon determining that the privacy flag is set as the first state, the labeling module 220 is configured to generate masked transaction data for the payment transaction based, at least in part, on masking a plurality of data fields associated with the payment transaction with NULL values in the transaction data. In other words, the labeling module 220 masks the plurality of data fields associated with the payment transaction in the transaction data 224 with NULL or zero values. The masked plurality of data fields may be stored as masked transaction data in the database 204 associated with the server system 200. Furthermore, the labeling module is configured to transmit the masked transaction data to the third party server 126 associated with the plurality of service providers.

In an alternative non-limiting scenario, upon determining that the privacy flag is set as the second state, the labeling module 220 is configured to transmit the transaction data to the third party server 126 associated with at least one of the plurality of service providers. In other words, if it is determined by the labeling module 220 that the transaction data is set as public by the cardholder 104, then the same can be transmitted to the plurality of service providers without any alterations.

In yet another embodiment, upon receiving the transaction insight request, the labeling module 220 is configured to determine a country code associated with the payment transaction data based, at least in part, on the transaction data. In particular, the labeling module 220 may extract or access the country code associated with the payment transaction from the transaction data of the cardholder 104.

Further, the labeling module 220 is configured to access the set of pre-defined rules 226 from the database 204 associated with the server system 200. Furthermore, the labeling module 220 is configured to mask at least one of a plurality of data fields associated with the payment transaction with NULL values in the transaction data based, at least in part, on the country code and a set of pre-defined rules 226. Then, the labeling module 220 is configured to generate the regulated transaction data for the payment transaction based, at least in part, on the masking step. Thereafter, the labeling module 220 is configured to transmit the regulated transaction data to the third party server 126 associated with at least one of the plurality of service providers.

It is noted that the set of pre-defined rules 226 may be provided by an administrator associated with the server system 200 or one or more regulatory bodies associated with one or more governments. As may be understood, different countries or governments have their own data privacy rules and policies. These data privacy rules or policies may vary from country to country, to that end, the set of defined rules may indicate these different data privacy rules and policies associated with each of these countries using the country code. In other words, the set of pre-defined rules 226 may define which data fields from the plurality of data fields must be masked by the labeling module 220 for a particular country before transmitting this regulated transaction data to the plurality of service providers to comply with the data privacy rules and policies of that particular country.

In another embodiment, in response to receiving the transaction authorization message, the labeling module 220 is configured to generate a transaction successful message for the cardholder 104. It is noted that the transaction successful is generally generated to inform the cardholder 104 of the payment transaction is successful. As may be understood, these the transaction authorization messages received by the cardholder 104 may also be exploited by the plurality of service providers whose Mobile Applications (or Apps) are installed on the electronic device of the cardholder 104. It is noted that these Apps may read through such transaction successful messages to extract transaction related insights for payment transactions as well.

To that end, while generating the transaction successful message the labeling module 220 is configured to mask the one or more transaction related information within the transaction successful message. More specifically, the labeling module 220 at first determines whether the privacy flag is set as the first state for the payment transaction based, at least in part, on the transaction data. Upon determining that the privacy flag is set as the first state, the masks the one or more transaction related information within the transaction successful message. Furthermore, the labeling module 220 transmits the transaction successful message including the masked one or more transaction related information to the electronic device 120 associated with the cardholder 104. In an alternative scenario, if the privacy flag is set as the second state for the payment transaction, then the labeling module 220 transmits the transaction successful message to the electronic device associated with the cardholder 104 without any masking or alteration. In a non-limiting example, the transaction successful message is at least one of a Short Message Service (SMS), an Electronic mail (e-mail), and the like.

In another embodiment, the labeling module 220 may be configured to enable a cardholder 104 to assign at least one of the privacy label or the public label to an ongoing or live payment transaction.

In this embodiment, upon receiving a transaction authorization request message associated with an ongoing payment transaction, the labeling module 220 is configured to request the GUI generation module 222 to generate the first GUI on the electronic device of the cardholder 104. As described earlier, the first GUI may include, but is not limited to, a first option for assigning a privacy label to the payment transaction and a second option for assigning a public label to the payment transaction. Further, the labeling module 220 is configured to perform at least one of the first step or the second step described earlier.

In other words, the labeling module 220 facilitates the cardholder 104 to assign at least one of the privacy label or the public label to each payment transaction even if the same is either ongoing or complete. To that end, the server system 102 provides the cardholder 104 with the ability to control the privacy level associated with each payment transaction performed by him either in real-time or retroactively within a pre-defined time period.

In a non-limiting example, an exemplary representation of transaction data and marked transaction data that is received by at least one of the plurality of service providers 118 is provided below:

| Transaction Data | Masked Transaction data |
|---|---|
| API Object | API Object |
| { | { |
| { | { |
| “account_id”: “ABCDE”, | “account_id”: “ABCDE”, |
| “amount”: 2307.21, | “amount”: 2307.21, |
| “iso_currency_code”: “USD”, | “iso_currency_code”: “Null”, |
| “unofficial_currency_code”: null, | “unofficial_currency_code”: null, |
| “category”: [ | “category”: [ |
| “Shops”, | “Null”, |
| “Computers and Electronics” | “Null” |
| ], | ], |
| “date”: “2022-02-03”, | “date”: “2022-02-03”, |
| “authorized_date”: “2022-02-03”, | “authorized_date”: “2022-02-03”, |
| “authorized_datetime”: “2022-02- | “authorized_datetime”: “2022-02- |
| 03T10: 34: 50Z”, | 03T10: 34: 50Z”, |
| “location”: { | “location”: { |
| “address”: “300 ABC”, | “address”: “300 ABC”, |
| “city”: “XYZ”, | “city”: “XYZ”, |
| “region”: “CA”, | “region”: “CA”, |
| “postal_code”: “942xx”, | “postal_code”: “942xx”, |
| “country”: “IN”, | “country”: “IN”, |
| “lat”: 40.740512, | “lat”: 40.740512, |
| “lon”: −74.001871, | “lon”: −74.001871, |
| }, | }, |
| “name”: “Amazon Store”, | “name”: “Null”, |
| “merchant_name”: “Amazon”, | “merchant_name”: “Null”, |
| “payment_channel”: “in store”, | “payment_channel”: “Null”, |
| } | } |

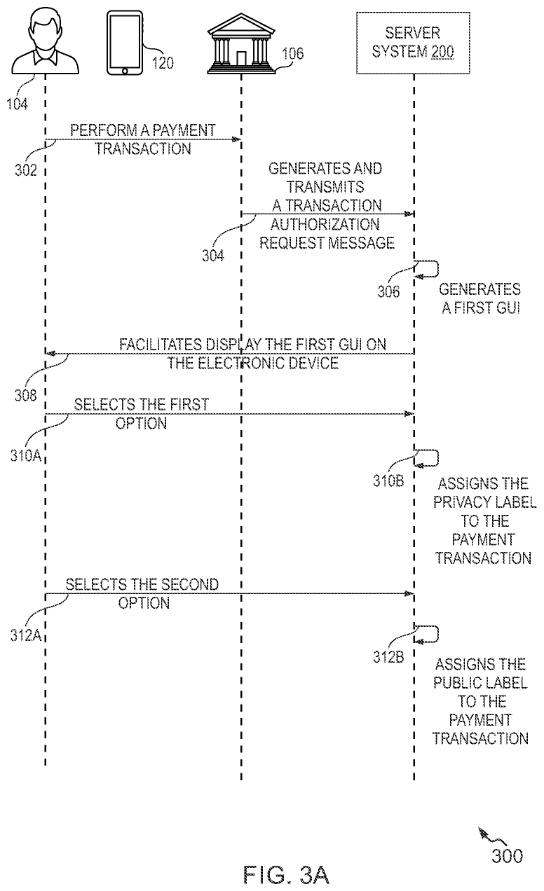

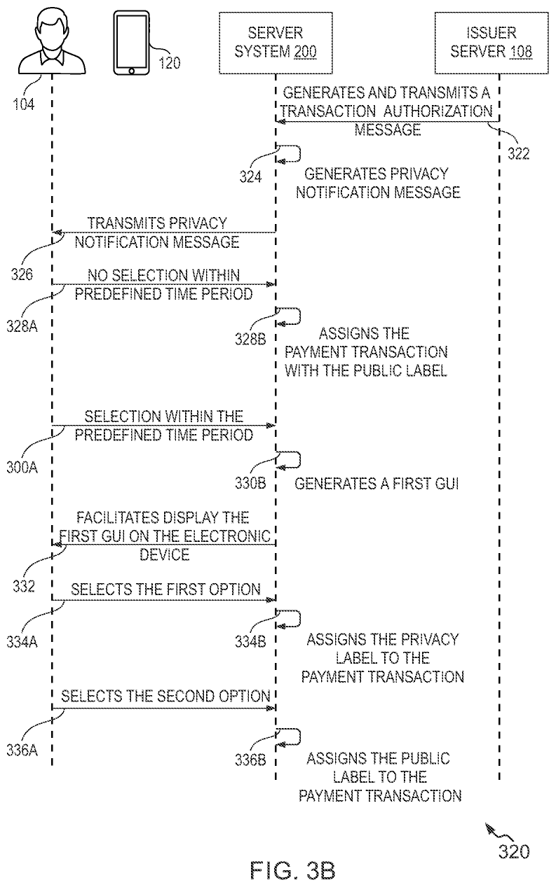

FIG. 3A is a sequence flow diagram 300 depicting a process for assigning at least one of a private label or a public label to an ongoing payment transaction by a cardholder (such as cardholder 104) in a payment network, in accordance with an embodiment of the present disclosure. The sequence of operations of the sequence flow diagram 300 may not be necessarily executed in the same order as they are presented. Further, one or more operations may be grouped and performed in the form of a single step, or one operation may have several sub-steps that may be performed in parallel or in a sequential manner. It is to be noted that to explain the sequence flow diagram 300, references may be made to elements described in FIGS. 1-2. It is understood that the various steps of the sequence flow have already been explained with reference to FIGS. 1 and 2, therefore an explanation for the same is not repeated herein for the sake of brevity. The sequence flow begins at step 302.

At step 302 the cardholder 104 performs a payment transaction with a merchant such as merchant 106.

At step 304, the merchant generates and transmits a transaction authorization request message associated with the ongoing payment transaction to the server system 200.

At step 306, the server system 200 generates a first GUI to be displayed on a display associated with the electronic device of the cardholder 104. In a non-limiting example, the GUI may include a first option for assigning the privacy label to the payment transaction and a second option for assigning the public label to the payment transaction.

At 308, the server system 200 facilitates the display of the first GUI on the display associated with the electronic device of the cardholder. In a particular implementation, if the payment transaction is an online payment, then the first GUI may be facilitated to be included in the existing payment gateway being displayed to the cardholder 104 by the payment server 114. In another implementation, if the payment transaction is a CP transaction at a POS device of the merchant 106, then the first GUI may be facilitated to be included in the existing payment gateway being displayed on the POS device of the merchant 106.

As may be understood, if at step 310A, the cardholder 104 selects the first option on the first GUI on their electronic device then, at step 310B the server system assigns the privacy label to the payment transaction.

Alternatively, if at step 312A, the cardholder 104 selects the second option on the first GUI on their electronic device then, at step 312B, the server system assigns the public label to the payment transaction.

FIG. 3B is a sequence flow diagram 320 depicting a process for assigning at least one of a private label or a public label to a completed payment transaction by a cardholder (such as the cardholder 104) in a payment network, in accordance with an embodiment of the present disclosure. The sequence of operations of the sequence flow diagram 320 may not be necessarily executed in the same order as they are presented. Further, one or more operations may be grouped and performed in the form of a single step, or one operation may have several sub-steps that may be performed in parallel or in a sequential manner. It is to be noted that to explain the sequence flow diagram 320, references may be made to elements described in FIGS. 1-2. It is understood that the various steps of the sequence flow have already been explained with reference to FIGS. 1 and 2, therefore an explanation for the same is not repeated herein for the sake of brevity. The sequence flow begins at step 322.

At step 322, upon successful authorization of the payment transaction, the issuer server 108 generates and transmits a transaction authorization message associated with the completed payment transaction performed between the cardholder 104 and the merchant 106 to the server system 200.

At step 324, the server system 200 generates a privacy notification message for the payment transaction for the cardholder 104. In a non-limiting example, the privacy notification message may include at least a web link for assigning at least one of a privacy label or a public label to the payment transaction. In an implementation, the web link may be valid for a pre-defined time period.

At step 326, the server system transmits the privacy notification message to an electronic device 120 associated with the cardholder 104.

At step 328A, if the cardholder 104 does not select or open the web link inside the privacy notification message within the pre-defined time period, the server system 200 automatically assigns the payment transaction with the public label at step 328B.

At 330A, if the cardholder 104 selects the web link inside the privacy notification message within the pre-defined time period, then the server system 200 generates a first GUI to be displayed on a display associated with the electronic device of the cardholder 104 at step 330B. In a non-limiting example, the GUI may include a first option for assigning the privacy label to the payment transaction and a second option for assigning the public label to the payment transaction.

At 332, the server system 200 facilitates the display of the first GUI on the display associated with the electronic device 120 of the cardholder 104. In a particular implementation, the first GUI may be generated in the form of a payment gateway and opened on a web browser application installed on the electronic device 120 of the cardholder 104.

As may be understood, if at step 334A, the cardholder 104 selects the first option on the first GUI on their electronic device then, at step 334B, the server system assigns the privacy label to the payment transaction.

Alternatively, if at step 336A, the cardholder 104 selects the second option on the first GUI on their electronic device then, at step 336B the server system assigns the public label to the payment transaction.

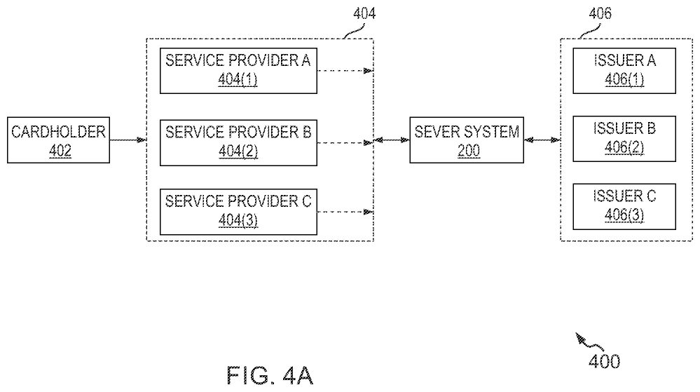

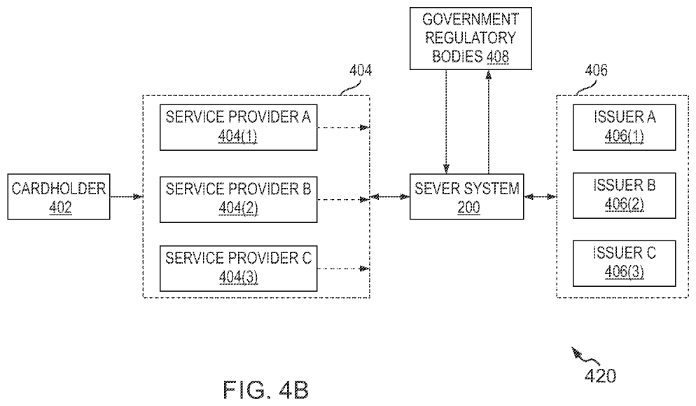

FIG. 4A illustrates a block diagram representation 400 of a process of sharing or transmitting masked transaction data to at least one of the plurality of service providers 404, in accordance with an embodiment of the present disclosure. It is noted that in the cardholder 402 depicted in the FIG. 4A is identical to the cardholder 104 of FIG. 1. As depicted in FIG. 4A, the cardholder 402 may be associated with a service provider A 404(1), a service provider B 404(2), and a service provider C 404(3). For instance, the cardholder 402 might have subscribed to a VAS service provided by each of these service providers 404(1)-404(3). For example, the service provider A 404(1) may be a third-party payment App installed by the cardholder 402 on their electronic device such as electronic device 120 that may provide a billing insight as a VAS to the cardholder 402. Similarly, the service provider B 404(2) may be a utility merchant App installed by the cardholder 402 on their electronic device 120 that may provide a spend analysis-related insight as a VAS, and the service provider C 404(3) may be an e-commerce merchant App installed by the cardholder 402 on their electronic device 120 that may provide a monthly statement related insight as a VAS.

It is understood that each of the service providers may generate and send a transaction insight request to the issuer server associated with the cardholder 402. In an implementation, the transaction insight request may be an API call initiated by any of the service providers. As may be understood, since the cardholder 402 may hold different payment cardholders provided by different issuing banks, therefore the FIG. 4A depicts issuer A 406(1), issuer B 406(2), and issuer C 406(3). It is noted that conventionally, these API calls were directly shared with the issuer servers 406(1)-406(2) directly providing the transaction data for a plurality of payment transactions to these service providers. However, now these API calls are passed through the server system 200. As per the present implementation, upon receiving the transaction insight request for the payment transaction from at least one of the service providers 404(1)-404(3), the server system 200 is configured to first determine whether the privacy flag is set as one of the first state and the second state for the payment transaction based, at least in part, on the transaction data. In a non-limiting scenario, the transaction data may be accessed by the server system 200 from the database 204 associated with it. Once, the server system 200 determines that the privacy flag is set as the first state, i.e., privacy flag is enabled for the transaction, the server system 200 is configured to generate masked transaction data for the payment transaction. In particular, the masked transaction data is generated based, at least in part, on masking a plurality of data fields associated with the payment transaction with NULL values in the transaction data. Further, the server system 200 transmits this masked transaction data to the third party server 126 associated with at least one of the plurality of service providers in response to their API calls. Alternatively, if the server system 200 determines that the privacy flag is set as the second state, i.e., the privacy flag is not enabled by the cardholder 402 for the transaction, then the server system 200 may directly transmit the transaction data to the third party server 126 associated with at least one of the plurality of service providers in response to their API calls.

FIG. 4B illustrates a block diagram representation 420 of a process of sharing or transmitting masked transaction data to at least one of the plurality of service providers 404, in accordance with an embodiment of the present disclosure. It is noted that the various components of FIG. 4B has already been explained with reference to FIG. 4A, therefore the same explanation is not repeated for the sake of brevity.

As may be understood, sometimes although the cardholder 402 may not have privacy concerns rather the government regulatory bodies may have privacy concerns for the sake of the country's citizens. To that end, there exists a need to provide privacy labels to a plurality of data fields indicated by the government's regulatory bodies such as government regulatory body 208. The server system 200 may automatically mask data fields based on the rules and policies of the government's regulatory bodies. In a non-limiting example, a data field may indicate if a transaction is to be masked based on government regulations. For example, data field 121 may be used to indicate that the corresponding transaction should be masked based on the corresponding government regulations.

In one implementation, upon receiving the transaction insight request for the payment transaction from at least one of a plurality of service providers, the server system 200 may at first determine a country code associated with the payment transaction based, at least in part, on the transaction data. As may be noted, the transaction includes information related to the country code of the transaction, and the same can be extracted by the server system 200 to determine the country code associated with the payment transaction.

Then, the server system 200 may be configured to mask at least one of a plurality of data fields associated with the payment transaction with NULL values in the transaction data based, at least in part, on the country code and a set of pre-defined rules 226. As may be understood, this set of pre-defined rules 226 is provided by the government regulatory bodies 408. In particular, the set of pre-defined rules 226 may define which data fields to automatically mask for which countries. For instance, multiple data fields may be masked based on the set of predefined rules 226. Further, the server system 200 may generate regulated transaction data for the payment transaction based, at least in part, on the masking step. In other words, masked data fields may be replaced in an instance of transaction data and this instance may be called the regulated transaction data. Further, the server system 200 may transmit the regulated transaction data to the third party server 126 associated with at least one of the plurality of service providers.

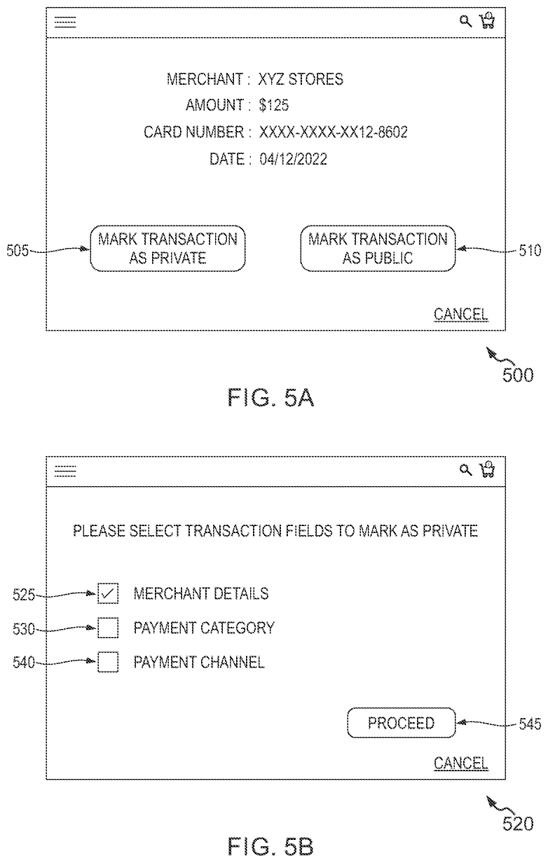

FIGS. 5A and 5B, collectively, represent a series of exemplary Graphical User Interfaces (GUIs) implemented on an electronic device such as electronic device 120 for assigning a private label or a public label to a payment transaction, in accordance with one or more embodiments of the present disclosure. The GUI 500 (such as the first GUI) includes an interface that is shown to a cardholder, such as the cardholder 104, on their electronic device 120, upon selecting a web link included in the privacy notification message for a corresponding payment transaction. The GUI 500 corresponds to a webpage associated with a payment gateway webpage, where the cardholder 104 is requested to select one of two options (see, 505 and 510) included in the GUI 500. As illustrated, the first option is a ‘MARK TRANSACTION AS PRIVATE’ option 505 (referred to hereinafter as ‘first option 505’) and the second option is a ‘MARK TRANSACTION AS PUBLIC’ option 510 (referred to hereinafter as ‘second option 510’). In the illustrated example, if the cardholder 500 selects the first option 505, a private label is assigned to the corresponding payment transaction. Alternatively, if the cardholder 500 selects the second option 505, a public label is assigned to the corresponding payment transaction.

In a particular non-limiting example, in response to the selection of the first option 505, a second GUI 520 is shown to the cardholder 104 on their electronic device 120. In some scenarios, upon selection of the first option 505, the webpage may redirected to the second GUI 520. As illustrated, the second GUI 520 may include a set of masking options (see, 525, 530, and 540) corresponding to a plurality of data fields associated with the corresponding payment transaction in the transaction data. For instance, the plurality of data fields illustrated include merchant details, payment category, and payment channel. Now, the cardholder 104 may select a subset of masked options corresponding to a plurality of data fields associated with the corresponding payment transaction to mask those data fields in the transaction data. In the illustrated example, the cardholder 104 selects masking option 525 corresponding to merchant details (i.e., the data field) to mask within the transaction data. To confirm this selection, the cardholder 104 may select the PROCEED option 545. Upon receiving, the confirmation from the cardholder, the server system 200 proceeds to mask the selected data field with a NULL value in the transaction data associated with the corresponding payment transaction. Furthermore, the cardholder 104 is also provided with a CANCEL option to exit from the label assignment process at any time in both the GUIs (500, and 520). As may be understood, once the cardholder exits the label assignment process, a public label may be assigned automatically to the corresponding payment transaction.

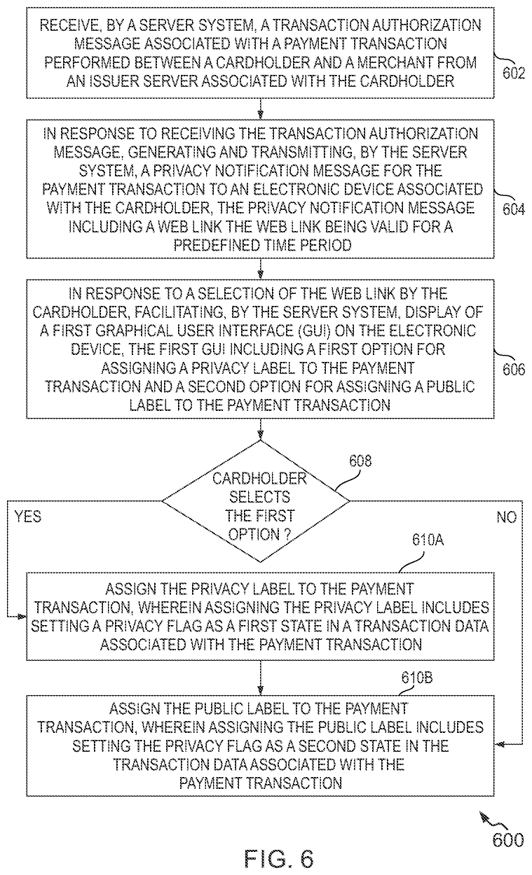

FIG. 6 illustrates a process flow diagram depicting a method 600 for assigning at least one of a private label or a public label to a completed payment transaction by a cardholder 104, in accordance with an embodiment of the present disclosure. The method 600 depicted in the flow diagram may be executed by, for example, the server system 200. The sequence of operations of the method 600 may not be necessarily executed in the same order as they are presented. Further, one or more operations may be grouped and performed in the form of a single step, or one operation may have several sub-steps that may be performed in parallel or in a sequential manner. Operations of the method 600, and combinations of operations in the method 600 may be implemented by, for example, hardware, firmware, a processor, circuitry, and/or a different device associated with the execution of software that includes one or more computer program instructions. The plurality of operations is depicted in the process flow of the method 600. The process flow starts at operation 602.

At 602, the method 600 includes receiving, by a server system such as server system 200, a transaction authorization message associated with a payment transaction performed between a cardholder such as the cardholder 104 and a merchant such as the merchant 106 from an issuer server such as issuer server 108 associated with the cardholder 104.

At 604, the method 600 includes in response to receiving the transaction authorization message, generating and transmitting, by the server system, a privacy notification message for the payment transaction to an electronic device such as electronic device 120 associated with the cardholder 104. In a non-limiting example, the privacy notification message includes a web link. Herein, the web link is valid for a pre-defined time period.

At 606, the method 600 includes in response to a selection of the web link by the cardholder 104, facilitating, by the server system, display of a first Graphical User Interface (GUI) on the electronic device 120. In a non-limiting example, the first GUI may include at least a first option for assigning a privacy label to the payment transaction and a second option for assigning a public label to the payment transaction.

At 608, the method 600 includes determining if the cardholder 104 has selected the first option. If YES, the method 600 flow moves to 610A, if NO, i.e., if the cardholder 104 has selected the second option, the method 600 flow moves to 610B.

At 610A, the method 600 includes assigning the privacy label to the payment transaction. Herein, assigning the privacy label includes setting a privacy flag as a first state in a transaction data associated with the payment transaction.

At 610B, the method 600 includes assigning the public label to the payment transaction. Herein, assigning the public label includes setting a privacy flag as a second state in a transaction data associated with the payment transaction.

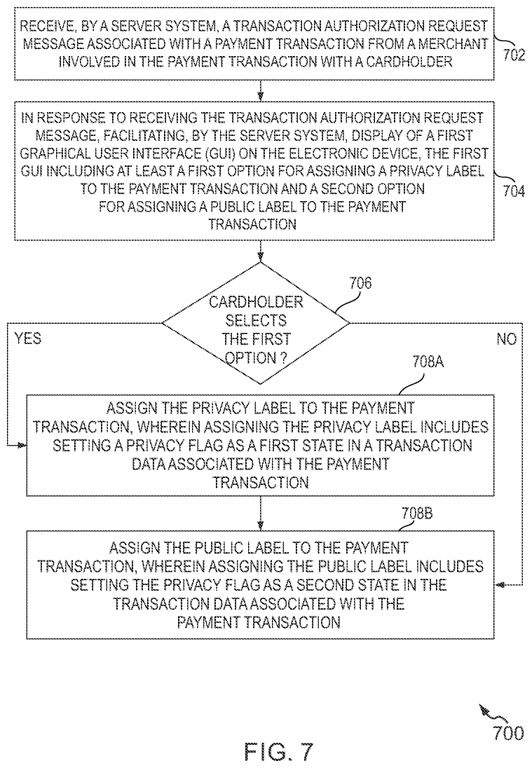

FIG. 7 illustrates a process flow diagram depicting a method 700 for assigning at least one of a private label or a public label to an ongoing payment transaction by a cardholder 104, in accordance with an embodiment of the present disclosure. The method 700 depicted in the flow diagram may be executed by, for example, the server system 200. The sequence of operations of the method 700 may not be necessarily executed in the same order as they are presented. Further, one or more operations may be grouped and performed in the form of a single step, or one operation may have several sub-steps that may be performed in parallel or in a sequential manner. Operations of the method 700, and combinations of operations in the method 700 may be implemented by, for example, hardware, firmware, a processor, circuitry, and/or a different device associated with the execution of software that includes one or more computer program instructions. The plurality of operations is depicted in the process flow of the method 700. The process flow starts at operation 702.

At 702, the method 700 includes receiving, by a server system such as server system 200, a transaction authorization request message associated with a payment transaction from a merchant such as merchant 106 involved in the payment transaction with a cardholder such as cardholder 104.

At 704, the method 700 includes in response to receiving the transaction authorization request message, facilitating, by the server system 200, display of a first GUI on the electronic device 120. In a non-limiting example, the first GUI may include at least a first option for assigning a privacy label to the payment transaction and a second option for assigning a public label to the payment transaction.

At 706, the method 700 includes determining if the cardholder 104 has selected the first option. If YES, the method 700 flow moves to 708A, if NO, i.e., if the cardholder 104 has selected the second option, the method 700 flow moves to 708B.

At 708A, the method 700 includes assigning the privacy label to the payment transaction. Herein, assigning the privacy label includes setting a privacy flag as a first state in a transaction data associated with the payment transaction.

At 708B, the method 700 includes assigning the public label to the payment transaction. Herein, assigning the public label includes setting a privacy flag as a second state in a transaction data associated with the payment transaction.

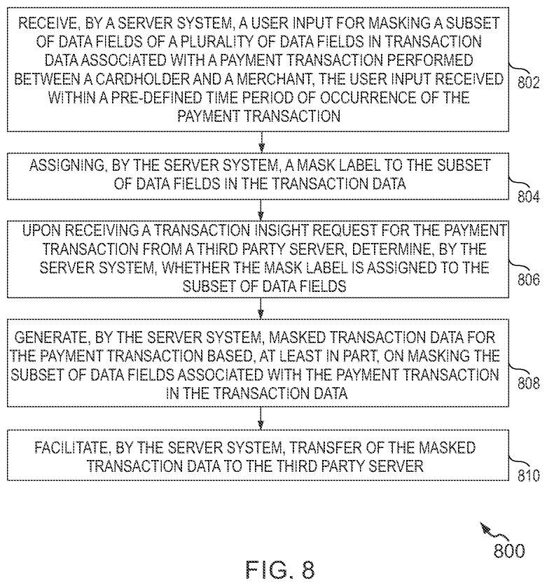

FIG. 8 illustrates a process flow diagram depicting a method 800 for masking a subset of data fields of a plurality of data fields in transaction data associated with a payment transaction, in accordance with an embodiment of the present disclosure. The method 800 depicted in the flow diagram may be executed by, for example, the server system 200. The sequence of operations of the method 800 may not be necessarily executed in the same order as they are presented. Further, one or more operations may be grouped and performed in the form of a single step, or one operation may have several sub-steps that may be performed in parallel or in a sequential manner. Operations of the method 800, and combinations of operations in the method 800 may be implemented by, for example, hardware, firmware, a processor, circuitry, and/or a different device associated with the execution of software that includes one or more computer program instructions. The plurality of operations is depicted in the process flow of the method 800. The process flow starts at operation 802.

At 802, the method 800 includes receiving, by a server system such as server system 200, a user input for masking a subset of data fields of a plurality of data fields in transaction data associated with a payment transaction performed between a cardholder 104 and a merchant 106. Herein, the user input is received within a pre-defined time period of occurrence of the payment transaction.

At 804, the method 800 includes assigning, by the server system 200, a mask label to the subset of data fields in the transaction data.

At 806, the method 800 includes upon receiving a transaction insight request for the payment transaction from a third party server 126, determining, by the server system 200, whether the mask label is assigned to the subset of data fields.

At 808, the method 800 includes generating, by the server system 200, masked transaction data for the payment transaction based, at least in part, on masking the subset of data fields associated with the payment transaction in the transaction data.

At 810, the method 800 includes facilitating, by the server system 200, transfer of the masked transaction data to the third party server 126.

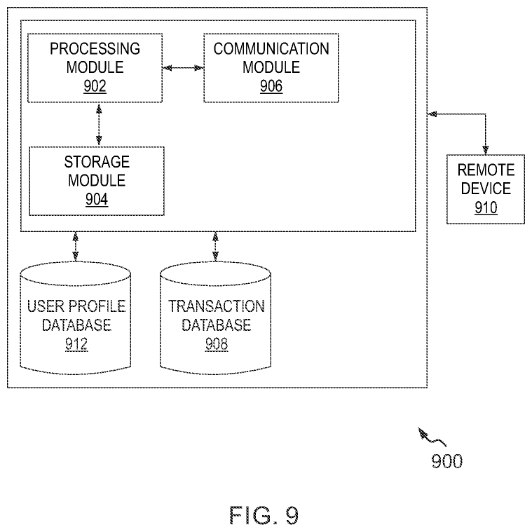

FIG. 9 illustrates a simplified block diagram of an acquirer server 900, in accordance with an embodiment of the present disclosure. The acquirer server 900 is an example of the acquirer server 110 of FIG. 1. The acquirer server 900 is associated with an acquirer bank/acquirer, in which a merchant may have an account, which provides a payment card. The acquirer server 900 includes a processing module 902 operatively coupled to a storage module 904 and a communication module 906. The components of the acquirer server 900 provided herein may not be exhaustive and the acquirer server 900 may include more or fewer components than those depicted in FIG. 9. Further, two or more components may be embodied in one single component, and/or one component may be configured using multiple sub-components to achieve the desired functionalities. Some components of the acquirer server 900 may be configured using hardware elements, software elements, firmware elements, and/or a combination thereof.

The storage module 904 is configured to store machine-executable instructions to be accessed by the processing module 902. Additionally, the storage module 904 stores information related to, contact information of the merchant, bank account number, availability of funds in the account, payment card details, transaction details, and/or the like. Further, the storage module 904 is configured to store payment transactions.

In one embodiment, the acquirer server 900 is configured to store profile data (e.g., an account balance, a credit line, details of the cardholders 104, account identification information, and a payment card number) in a transaction database 908. The details of the cardholders 104 may include, but are not limited to, name, age, gender, physical attributes, location, registered contact number, family information, alternate contact number, registered e-mail address, etc.

The processing module 902 is configured to communicate with one or more remote devices such as a remote device 910 using the communication module 906 over a network such as the network 116 of FIG. 1. The examples of the remote device 910 include the server system 102, the payment server 114, the issuer server 110, the plurality of service providers 118 or other computing systems of the acquirer server 900, and the like. The communication module 906 is capable of facilitating such operative communication with the remote devices and cloud servers using API (Application Program Interface) calls. The communication module 906 is configured to receive a payment transaction request performed by the cardholders 104 via the network 116. The processing module 902 receives payment card information, a payment transaction amount, customer information, and merchant information from the remote device 910 (i.e., the payment server 114). The acquirer server 900 includes a user profile database 912 and the transaction database 908 for storing transaction data. The user profile database 912 may include information of cardholders. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular user, transaction location information, external data sources, and other internal data to evaluate each transaction.

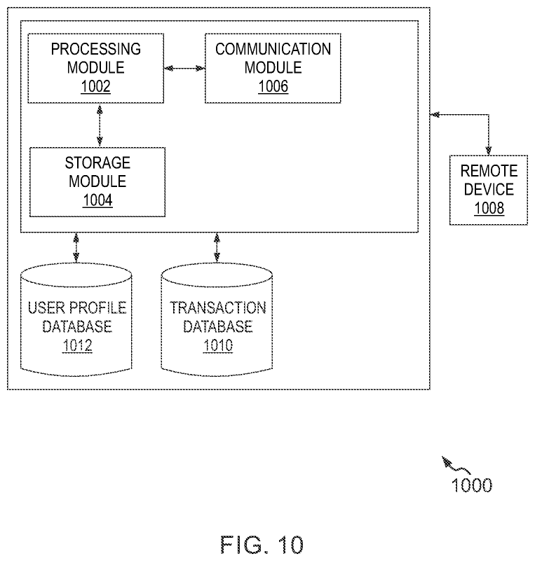

FIG. 10 illustrates a simplified block diagram of the issuer server 1000, in accordance with an embodiment of the present disclosure. The issuer server 1000 is an example of the issuer server 108 of FIG. 1. The issuer server 1000 is associated with an issuer bank/issuer, in which an account holder may have an account, which provides a payment card. The issuer server 1000 includes a processing module 1002 operatively coupled to a storage module 1024 and a communication module 1026. The components of the issuer server 1000 provided herein may not be exhaustive and the issuer server 1000 may include more or fewer components than those depicted in FIG. 10. Further, two or more components may be embodied in one single component, and/or one component may be configured using multiple sub-components to achieve the desired functionalities. Some components of the issuer server 1000 may be configured using hardware elements, software elements, firmware elements, and/or a combination thereof.

The storage module 1004 is configured to store machine-executable instructions to be accessed by the processing module 1002. Additionally, the storage module 1004 stores information related to, contact information of the cardholders, a bank account number, availability of funds in the account, payment card details, transaction details, payment account details, and/or the like. Further, the storage module 1004 is configured to store payment transactions.

In one embodiment, the issuer server 1000 is configured to store profile data (e.g., an account balance, a credit line, details of the cardholders, account identification information, payment card number, etc.) in a database. The details of the cardholders may include, but are not limited to, name, age, gender, physical attributes, location, registered contact number, family information, alternate contact number, registered e-mail address, or the like of the cardholders, etc.

The processing module 1002 is configured to communicate with one or more remote devices such as a remote device 1008 using the communication module 1006 over a network such as the network 116 of FIG. 1. Examples of the remote device 1008 include the server system 200, the payment server 114, the acquirer server 1010 or other computing systems of the issuer server 108. The communication module 1006 is capable of facilitating such operative communication with the remote devices and cloud servers using API (Application Program Interface) calls. The communication module 1006 is configured to receive a payment transaction request performed by an account holder via the network 116. The processing module 1002 receives payment card information, a payment transaction amount, customer information, and merchant information from the remote device 1008 (e.g., the payment server 114). The issuer server 1000 includes a transaction database 1010 for storing transaction data. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular account holder, transaction location information, external data sources, and other internal data to evaluate each transaction. The issuer server 1000 includes a user profile database 1012 storing user profiles associated with the plurality of account holders.

The user profile data may include an account balance, a credit line, details of the account holders, account identification information, payment card number, or the like. The details of the account holders may include, but are not limited to, name, age, gender, physical attributes, location, registered contact number, family information, alternate contact number, registered e-mail address, or the like of the cardholders.

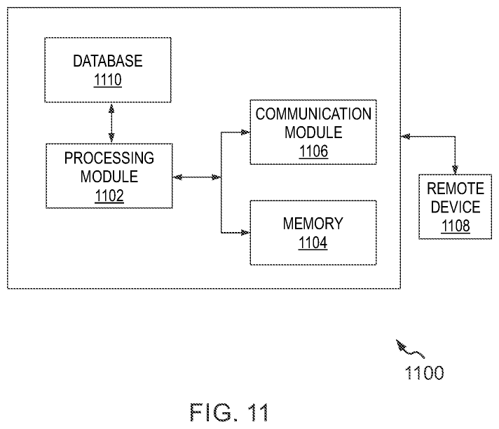

FIG. 11 illustrates a simplified block diagram of the payment server 1100, in accordance with an embodiment of the present disclosure. The payment server 1100 is an example of the payment server 114 of FIG. 1. The payment server 1100 and the server system 200 may use the payment network 112 as a payment interchange network. Examples of payment interchange networks include, but are not limited to, Mastercard® payment system interchange network.

The payment server 1100 includes a processing module 1102 configured to extract programming instructions from a memory 1104 to provide various features of the present disclosure. The components of the payment server 1100 provided herein may not be exhaustive and the payment server 1100 may include more or fewer components than that depicted in FIG. 11. Further, two or more components may be embodied in one single component, and/or one component may be configured using multiple sub-components to achieve the desired functionalities. Some components of the payment server 1100 may be configured using hardware elements, software elements, firmware elements, and/or a combination thereof.

Via a communication module 1106, the processing module 1102 receives a request from a remote device 1108, such as the issuer server 118, the acquirer server 110, or the server system 112. The request may be a request for conducting the payment transaction. The communication may be achieved through API calls, without loss of generality. The payment server 1100 includes a database 1110. The database 1110 also includes transaction processing data such as issuer ID, country code, acquirer ID, and merchant identifier (MID), among others.

When the payment server 1100 receives a payment transaction request from the acquirer server 118 or a payment terminal (e.g., IoT device), the payment server 1100 may route the payment transaction request to an issuer server (e.g., the issuer server 110). The database 1110 stores transaction identifiers for identifying transaction details such as transaction amount, IoT device details, acquirer account information, transaction records, merchant account information, and the like.

In one example embodiment, the acquirer server 110 is configured to send an authorization request message to the payment server 1100. The authorization request message includes, but is not limited to, the payment transaction request.

The processing module 1102 further sends the payment transaction request to the issuer server 110 for facilitating the payment transactions from the remote device 1108. The processing module 1102 is further configured to notify the remote device 1108 of the transaction status in form of an authorization response message via the communication module 1106. The authorization response message includes, but is not limited to, a payment transaction response received from the issuer server 110. Alternatively, in one embodiment, the processing module 1102 is configured to send an authorization response message for declining the payment transaction request, via the communication module 1106, to the acquirer server 118. In one embodiment, the processing module 1102 executes similar operations performed by the server system 200, however, for the sake of brevity, these operations are not explained herein.

The disclosed method with reference to FIGS. 3-8, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), CD-ROM (compact disc read-only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based on these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
receiving, by a server system, a user input for masking a subset of data fields of a plurality of data fields in transaction data associated with a payment transaction performed between a cardholder and a merchant, the user input received within a pre-defined time period of occurrence of the payment transaction;
assigning, by the server system, a mask label to the subset of data fields in the transaction data;
upon receiving a transaction insight request for the payment transaction from a third party server, determining, by the server system, whether the mask label is assigned to the subset of data fields;
generating, by the server system, masked transaction data for the payment transaction based, at least in part, on masking the subset of data fields associated with the payment transaction in the transaction data; and
facilitating, by the server system, transfer of the masked transaction data to the third party server.

2. The computer-implemented method as claimed in claim 1, wherein receiving the user input comprises:
receiving, by a server system, a transaction authorization message associated with the payment transaction from an issuer server associated with the cardholder;
in response to receiving the transaction authorization message, generating and transmitting, by the server system, a privacy notification message for the payment transaction to an electronic device associated with the cardholder, the privacy notification message comprising a web link, the web link being valid for the pre-defined time period;
in response to a selection of the web link by the cardholder, facilitating, by the server system, display of a first graphical user interface (GUI) on the electronic device, the first GUI comprising a first option for assigning a privacy label to the payment transaction and a second option for assigning a public label to the payment transaction; and
performing, by the server system, at least one of:
in response to a selection of the first option by the cardholder, assigning the privacy label to the payment transaction, wherein assigning the privacy label comprises setting a privacy flag as a first state in the transaction data associated with the payment transaction, and
in response to a selection of the second option by the cardholder, assigning the public label to the payment transaction, wherein assigning the public label comprises setting the privacy flag as a second state in the transaction data associated with the payment transaction.

3. The computer-implemented method as claimed in claim 2, further comprising:
in response to a selection of the first option by the cardholder facilitating, by the server system, display of a second GUI on the electronic device, the second GUI comprising a set of masking options corresponding to the plurality of data fields associated with the payment transaction, wherein each masking option of the set of masking options enables the cardholder to mask a corresponding data field from the plurality of data fields; and
receiving, by the server system, the user input indicating a selection of a subset of masking options corresponding to the subset of data fields from the set of masking options by the cardholder.

4. The computer-implemented method as claimed in claim 2, further comprising:
assigning, by the server system, the public label to the payment transaction based, at least in part, on determining that the cardholder has not selected the web link within the pre-defined time period, wherein assigning the public label comprises setting the privacy flag as the second state in the transaction data associated with the payment transaction.

5. The computer-implemented method as claimed in claim 2, further comprising:
upon receiving the transaction insight request for the payment transaction from the third party server, determining, by the server system, whether the privacy flag is set as one of the first state and the second state for the payment transaction based, at least in part, on the transaction data; and
upon determining that the privacy flag is set as the second state, transmitting, by the server system, the transaction data to the third party server.

6. The computer-implemented method as claimed in claim 2, further comprising:
in response to receiving the transaction authorization message, generating, by the server system, a transaction successful message comprising one or more transaction related information for the payment transaction, wherein one or more transaction related information is masked with NULL value based, at least in part, on determining that the privacy flag is set as the first state for the payment transaction based, at least in part, on the transaction data; and
transmitting, by the server system, the transaction successful message comprising the masked one or more transaction related information to the electronic device associated with the cardholder.

7. The computer-implemented method as claimed in claim 2, wherein the privacy notification message and the transaction successful message are at least one of a Short Message Service (SMS) and an Electronic mail (E-mail).

8. The computer-implemented method as claimed in claim 1, wherein assigning the mask label comprises masking the subset of data fields with a NULL value in the transaction data associated with the payment transaction.

9. The computer-implemented method as claimed in claim 1, further comprising:
receiving, by the server system, the transaction insight request for the payment transaction from the third party server;
determining, by the server system, a country code associated with the payment transaction based, at least in part, on the transaction data;
masking, by the server system, at least one of a plurality of data fields associated with the payment transaction with NULL values in the transaction data based, at least in part, on the country code and a set of pre-defined rules;
generating, by the server system, regulated transaction data for the payment transaction based, at least in part, on the masking step; and
transmitting, by the server system, the regulated transaction data to the third part server.

10. The computer-implemented method as claimed in claim 1, further comprising:
receiving, by the server system, a transaction authorization request message associated with the payment transaction from the merchant;
in response to receiving the transaction authorization request message, facilitating, by the server system, the display of a first GUI on an electronic device, the first GUI comprising a first option for assigning a privacy label to the payment transaction and a second option for assigning a public label to the payment transaction; and
performing, by the server system, at least one of:
in response to a selection of the first option by the cardholder assigning the privacy label to the payment transaction, and
in response to a selection of the second option by the cardholder assigning the public label to the payment transaction.

11. The computer-implemented method as claimed in claim 1, wherein the server system is at least one of a payment server associated with a payment network and an issuer server associated with the cardholder.

12. A server system, comprising:
a memory configured to store instructions;
a communication interface; and
a processor in communication with the memory and the communication interface, the processor configured to execute the instructions stored in the memory and thereby cause the server system to perform at least in part to:
receive a user input for masking a subset of data fields of a plurality of data fields in transaction data associated with a payment transaction performed between a cardholder and a merchant, the user input received within a pre-defined time period of occurrence of the payment transaction;
assign a mask label to the subset of data fields in the transaction data;
upon receiving a transaction insight request for the payment transaction from a third party server, determine whether the mask label is assigned to the subset of data fields;
generate masked transaction data for the payment transaction based, at least in part, on masking the subset of data fields associated with the payment transaction in the transaction data; and
facilitate transfer of the masked transaction data to the third party server.

13. The server system as claimed in claim 12, wherein to receive the user input the server system is further caused, at least in part, to:
receive a transaction authorization message associated with the payment transaction from an issuer server associated with the cardholder;
in response to receiving the transaction authorization message, generate and transmit a privacy notification message for the payment transaction to an electronic device associated with the cardholder, the privacy notification message comprising a web link, the web link being valid for the pre-defined time period;
in response to a selection of the web link by the cardholder, facilitate display of a first graphical user interface (GUI) on the electronic device, the first GUI comprising a first option for assigning a privacy label to the payment transaction and a second option for assigning a public label to the payment transaction; and
perform at least one of:
in response to a selection of the first option by the cardholder, assigning the privacy label to the payment transaction, wherein assigning the privacy label comprises setting a privacy flag as a first state in the transaction data associated with the payment transaction, and
in response to a selection of the second option by the cardholder, assigning the public label to the payment transaction, wherein assigning the public label comprises setting the privacy flag as a second state in the transaction data associated with the payment transaction.

14. The server system as claimed in claim 13, wherein the server system is further caused, at least in part, to:
in response to a selection of the first option by the cardholder facilitate display of a second GUI on the electronic device, the second GUI comprising a set of masking options corresponding to the plurality of data fields associated with the payment transaction, wherein each masking option of the set of masking options enables the cardholder to mask a corresponding data field from the plurality of data fields; and
receive the user input indicating a selection of a subset of masking options corresponding to the subset of data fields from the set of masking options by the cardholder.

15. The server system as claimed in claim 13, wherein the server system is further caused, at least in part, to:
assign the public label to the payment transaction based, at least in part, on determining that the cardholder has not selected the web link within the pre-defined time period, wherein assigning the public label comprises setting the privacy flag as the second state in the transaction data associated with the payment transaction.

16. The server system as claimed in claim 13, wherein the server system is further caused, at least in part, to:
upon receiving the transaction insight request for the payment transaction from the third party server, determining, by the server system, whether the privacy flag is set as one of the first state and the second state for the payment transaction based, at least in part, on the transaction data; and
upon determining that the privacy flag is set as the second state, transmitting, by the server system, the transaction data to the third party server.

17. The server system as claimed in claim 12, wherein assigning the mask label comprises masking the subset of data fields with a NULL value in the transaction data associated with the payment transaction.

18. The server system as claimed in claim 12, wherein the server system is further caused, at least in part, to:
receive the transaction insight request for the payment transaction from the third party server;
determine a country code associated with the payment transaction based, at least in part, on the transaction data;
mask at least one of a plurality of data fields associated with the payment transaction with NULL values in the transaction data based, at least in part, on the country code and a set of pre-defined rules;
generate regulated transaction data for the payment transaction based, at least in part, on the masking step; and
transmit the regulated transaction data to the third part server.

19. The server system as claimed in claim 12, wherein the server system is further caused, at least in part, to:
receive a transaction authorization request message associated with the payment transaction from the merchant;
in response to receiving the transaction authorization request message, facilitate the display of a first GUI on an electronic device, the first GUI comprising a first option for assigning a privacy label to the payment transaction and a second option for assigning a public label to the payment transaction; and
perform at least one of:
in response to a selection of the first option by the cardholder assigning the privacy label to the payment transaction, and
in response to a selection of the second option by the cardholder assigning the public label to the payment transaction.

20. A non-transitory computer-readable storage medium comprising computer-executable instructions that, when executed by at least a processor of a server system, cause the server system to perform a method comprising:
receiving a user input for masking a subset of data fields of a plurality of data fields in transaction data associated with a payment transaction performed between a cardholder and a merchant, the user input received within a pre-defined time period of occurrence of the payment transaction;
assigning a mask label to the subset of data fields in the transaction data;
upon receiving a transaction insight request for the payment transaction from a third party server, determining whether the mask label is assigned to the subset of data fields;
generating masked transaction data for the payment transaction based, at least in part, on masking the subset of data fields associated with the payment transaction in the transaction data; and
facilitating transfer of the masked transaction data to the third party server.
